(19) United States
(12) Patent Application Publication
(10) Pub. No.: US 2021/0086415 A1
(43) Pub. Date: Mar. 25, 2021

(54) LASER-STRUCTURED SURFACE

(71) Applicant: HIRSCHMANN AUTOMOTIVE GMBH, Rankweil/Brederis (AT)

(72) Inventors: Alexander SCHMID, Rankweil (AT); Wolfgang HOLZER, Schwarzenberg (AT)

(21) Appl. No.: 16/635,426

(22) PCT Filed: Aug. 30, 2018
(86) PCT No.: PCT/EP2018/073315

§ 371 Date: Jan. 30, 2020

(30) Foreign Application Priority Data
Sep. 11, 2017 (DE) 10 2017 120 894.1

(51) Int. Cl. B29C 45/14

(52) U.S. Cl. CPC B29C 45/14311; B29L 2031/3462; B29C 2045/14868

(57) ABSTRACT

Method for encapsulating in a plastics material part of a plug-in connector that is arranged on an electrical conductor of a cable having an outer sheath, wherein a surface treatment is carried out in a region of the plug-in connector that is encapsulated, characterized in that the surface treatment is carried out with a laser.

The invention relates to a method of injection molding plastic around a part of a plug-in connector that is on a cable having an outer sheath surrounding a conductor, a surface treatment being carried out on the part of the plug-in connector where the injection molding is effected, according to the features of the characterizing clause of patent claim 1.

This invention generally concerns sealing the joint between an electrical conductor and a plug-in connector. In particular, it concerns the connection of the weld between an electrical cable and a ring-cable terminal (shunt).

The sealing is intended to enclose the ring-cable terminal before the start of the weld and extend further over this weld to the insulation of the outgoing cable, and therefore to protect the weld against external stresses (in particular tensile or compressive stress) and to seal it (in particular longitudinal water-tightness).

The challenge is that on the one hand there is a metal as a partner for the injection molding, and on the other hand the plastic insulation of the outgoing cable material (outer sheath of the electrical conductor) must be taken into account as a partner.

There are oil-tight versions of structures which are applied into or onto by mechanically produced embossing onto the metal parts (contact regions). With these structures, the aim of oil-tightness would not ultimately be achieved.

While the existing and related construction of the ring-cable terminals (shunts) would theoretically indeed be suitable for such embossing, they would however lead to problems at another position. In particular, there is in principle the risk that both in the case of plug-in connectors in general, but also in the case of a ring-cable terminal, the connection with the electrical conductor is damaged in the case of such mechanically produced embossing, which is under high pressure. Such damage leads, for example, to unacceptably high junction resistances, while at the same time the risk also exists that microcracks will be formed there as a result of vibrations to which the plug-in connector is exposed at its place of use (for example in a vehicle), these microcracks being capable not only of contributing to the high junction resistances but also of leading to a complete electrical break.

The object of the invention is therefore to improve such a method of this type and to avoid these disadvantages explained above.

This object is achieved by the features of patent claim 1.

According to the invention, the surface treatment is carried out with a laser. With such a surface treatment of the plug-in connector, it is possible for regions of the surface to be shapingly transformed, in particular roughened, into which the plastic can penetrate during the subsequent injection molding, in order to achieve the required leak tightness, in particular longitudinal water-tightness. Furthermore, the surface treatment by means of a laser preserves the mechanical structure of the plug-in connector, in particular of that region where the electrical conductor is connected to the plug-in connector, so that damage such as occurs in the case of mechanically introduced embossing cannot occur there.

According to one refinement of the invention, the surface treatment is carried out transversely with respect to the longitudinal extent of the plug-in connector and circumferentially around the latter. The solution according to the invention resides in a laser-structured surface that is applied circumferentially onto the plug-in connector, in particular the ring-cable terminal, in a particular region and transversely there—and around which injection molding can subsequently be carried out.

According to one refinement of the invention, the surface treatment is carried out starting from a region of the plug-in connector to the electrical conductor, in particular the outer sheath thereof. Therefore, not only is a region of the plug-in connector treated in its surface by means of a laser, but also a part of the outer sheath, in particular the end region thereof, which emerges from the region where the (exposed) electrical conductor is connected to the plug-in connector. Such a surface treatment is rarely possible since both metallic materials (plug-in connector) and materials consisting of plastic (outer sheath) can be processed by means of the laser. Ideally, therefore, the entire region consisting of the outer sheath to be injection-molded around and the region to be injection-molded around of the plug-in connector is treated by means of the laser, so that the plastic subsequently injection-molded can penetrate into the treated regions and the required longitudinal water-tightness can therefore be ensured.

The injection-molding material used or provided (in particular a thermoplastic or alternatively a thermoset) is connected during the injection molding to the deliberately produced structure of the lasered surface in a particular way and with a particular quality. This connection will satisfy the requirements for leak tightness between the injection molding and the metallic surface. The leak tightness on the second jointly crucial side, namely the connected cable material, is ensured either by a conventional injection-molding process or likewise by, for example, a previously applied structured laser treatment of the insulation surface of the outgoing cable.

According to one refinement of the invention, the surface treatment is carried out where the electrical conductor is connected, in particular welded, to the plug-in connector, and/or the surface treatment is carried out adjacent where the electrical conductor is connected, in particular welded, to the plug-in connector. By means of the laser, only where the plug-in connector is connected (for example soldered, welded, crimped or the like) to the electrical conductor is thus treated in its surface. As an alternative or in addition, a further region of the plug-in connector adjacent this connection region may also be treated in its surface by means of a laser. Likewise as an alternative or in addition thereto, the outer sheath of the electrical conductor is also treated in its surface by means of the laser, preferably in its end region. More typically particularly preferably, the end region of the outer sheath, the connection position between the electrical conductor and the plug-in connector and optionally a region of the plug-in connector extending beyond this (in the direction of the contact region for a mating plug-in connector) are therefore treated in their surface by means of a laser and the plastic is therefore injection-molded around the region that is modified in its surface structure.

The invention therefore provides in particular, a laser-structured surface which is applied circumferentially onto a ring-cable terminal, in a particular region and transversely there—and around which injection molding is subsequently carried out, the injection-molding material used or provided (in particular a thermoplastic or alternatively a thermoset) being connected during the injection molding to the deliberately produced structure of the lasered surface in a particular way and with a particular quality.

1. A method comprising the steps of:
injection molding plastic around a part of a plug-in connector that is on a cable having an outer sheath surrounding a conductor, and
using a laser for surface treating the part of the plug-in connector where the injection molding is effected.

2. The method according to claim 1, wherein the surface treatment is carried out transversely with respect to a longitudinal extent of the plug-in connector and circumferentially around the latter.

3. The method according to claim 1, wherein the surface treatment is carried out starting from a region of the plug-in connector toward the electrical conductor.

4. The method according to claim 1, wherein a thermoplastic or a thermosetting resin is used as the plastic for the injection molding.

5. The method according to claim 1, wherein the surface treatment is carried out where the electrical conductor is welded to the plug-in connector.

6. The method according to claim 1, wherein the surface treatment is carried out adjacent where the electrical conductor is welded to the plug-in connector.

7. The method according to claim 1, wherein the surface treatment is effected on a ring terminal.

8. The method according to claim 1, wherein the surface treatment is done before the injection molding of the plastic to the part.
